(19) United States
(12) Patent Application Publication
(10) Pub. No.: US 2025/0363664 A1
(43) Pub. Date: Nov. 27, 2025

(54) POINT GRID NETWORK WITH LEARNABLE SEMANTIC GRID TRANSFORMATION

(71) Applicant: Intel Corporation, Santa Clara, CA (US)

(72) Inventors: Dongqi Cai, Beijing (CN); Anbang Yao, Beijing (CN); Yangyuxuan Kang, Beijing (CN); Shandong Wang, Beijing (CN); Yurong Chen, Beijing (CN)

(73) Assignee: Intel Corporation, Santa Clara, CA (US)

(21) Appl. No.: 18/997,988

(22) PCT Filed: Aug. 26, 2022
(86) PCT No.: PCT/CN2022/114976

§ 371 Date: Jan. 23, 2025

(51) Int. Cl. G06T 7/73; G06N 3/0464; G06N 3/09

(52) U.S. Cl. CPC G06T 7/75; G06N 3/0464; G06N 3/09; G06T 2207/20081; G06T 2207/20084

(57) ABSTRACT

A point grid network is a neural network that can model graph-structured data. The point grid network receives a graph-structured data sample, which may be a graph representation of an object. The point grid network uses an assignment matrix to transform the graph representation into a grid representation of the object. The assignment matrix defines whether graph nodes in the graph representation is to be assigned to grid elements in the grid structure. The grid representation is a tensor that can be processed through convolutional operations or other types of tensor operations. The point grid network can perform convolution on the grid representation and one or more filters to generate a grid-structured feature map. Values in the filter (s) and values in the assignment matrix are determined through training the point grid network. The point grid network may further determine a condition of the object based on the grid-structured feature map.

### TECHNICAL FIELD

This disclosure relates generally to deep neural networks (DNNs), and more specifically, to point grid network with learnable semantic grid transformation.

### BACKGROUND

DNNs are used extensively for a variety of artificial intelligence (AI) applications ranging from computer vision to speech recognition and natural language processing due to their ability to achieve high accuracy. One type of DNN is graph convolutional network (GCN). GCN is one of the prevailing solutions for various AI applications, such as human pose lifting, skeleton based human action recognition, mesh reconstruction, traffic navigation, social network analysis, recommend system, scientific computing, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example convolutional neural network (CNN), in accordance with various embodiments.

FIG. 2 is a block diagram of a point grid system, in accordance with various embodiments.

FIG. 3 illustrates a block diagram of an auto grid module, in accordance with various embodiments.

FIG. 4 illustrates a process of training a point grid network, in accordance with various embodiments.

FIG. 5 illustrates an inference of a point grid network, in accordance with various embodiments.

FIG. 6 illustrates an example semantic grid transformation by a point grid network, in accordance with various embodiments.

FIG. 7 illustrates an example convolution by a point grid network, in accordance with various embodiments.

FIG. 8 illustrates an example convolutional layer in a point grid network including multiple branches, in accordance with various embodiments.

FIG. 9 illustrates an example three-dimensional (3D) pose estimation by a grid lifting network, in accordance with various embodiments.

FIG. 10 illustrates a deep learning (DL) environment, in accordance with various embodiments.

FIG. 11 is a flowchart showing a method of modeling graph-structured data, in accordance with various embodiments.

FIG. 12 is a block diagram of an example computing device, in accordance with various embodiments.

### DETAILED DESCRIPTION

### Overview

GCNs are a variant of CNNs. GCNs are adopted to operate on data samples represented in the form of irregular graphic structures, such as images. Taking pose lifting network for example, pose lifting network is a specific type of GCN. A pose lifting network is usually trained to estimate 3D human pose given locations of body joints detected from a 2D input. Estimating 3D human pose from images and videos has a wide range of applications such as human action recognition, human robot/computer interaction, augmented reality, animation and gaming. Generally, existing pose lifting networks can be grouped into 4 solution families: (1) Fully Connected Network (FCN); (2) Semantic Graph Convolution Network (SGCN); (3) Locally Connected Network (LCN); and (4) other variants of FCN, SGCN and LCN. All these pose lifting networks operate based on data samples represented in the form of irregular graph structures.

However, the usage of such data samples can limit the performance of GCNs in certain image-based applications. Also, it can lead to irregular workloads, e.g., irregular sparse tensor operations. These irregular workloads prevent GCNs from being efficiently executed on many AI processors, such as GPUs (graphics processing units), CPUs (central processing units), VPUs (vision processing units), TPUs (tensor processing units), and so on. Therefore, improved techniques for convolutional operations on graph-structured data are needed.

Embodiments of the present disclosure may improve on at least some of the challenges and issues described above by providing methods and apparatus that facilitate modeling graph-structured data with point grid networks. In various embodiments of the present disclosure, a point grid network is a neural network that can be trained and make determinations based on graph-structured data samples through convolutions or other types of tensor operations.

An example point grid network includes an auto grid module and a convolutional module. The auto grid module is configured to perform auto semantic grid transformation, i.e., transformation of graph-structured data to grid-structured data. The auto grid module can use an assignment matrix to transform a graph-structured data sample to a grid-structured data sample. The assignment matrix is learnable. The values in the assignment matrix can be determined during the training of the point grid network, e.g., based on training data and definition of a task of the point grid network. The grid-structured data sample is a grid-structured tensor that can be processed with various tensor operations, such as convolutions, pooling operations, elementwise operations, and so on.

In some embodiments, the auto grid module uses values of elements in the assignment matrix to assign graph nodes in the graph-structured data sample to grid elements in a grid structure. The grid structure may be a weave-like grid structure. The auto grid module generates the assignment matrix from a learnable matrix. Values of elements in the learnable matrix are determined through a process of training the point grid network. The training process can also determine values of weights in one or more convolutional filter (also referred to as “filter”) that the convolutional module can use to perform a point grid convolution on the grid-structured data sample generated by the auto grid module. The convolutional operation can result in a grid-structured feature map. The point grid network may further process the feature map for making a determination, e.g., for estimation a condition of an object illustrated in the graph-structured data sample.

Through sematic grid transformation, the intrinsic relationships between the graph nodes are preserved. Also, data samples with irregular graphic structures are converted to data samples with regular grid structures. That way, the point grid convolution can have the merits of regular convolutions in CNNs and have better accuracy and efficiency than conventional GCNs. Also, the present disclosure automates sematic grid transformation by using the learnable matrix, which makes point grid networks to be automatic grid representation learners. Such point grid networks can handle various AI applications and can achieve significantly better performance. For instance, a point grid network can determine a condition of an object. Examples of the condition include a classification, a pose, an action, a mood, an orientation, an interest, a traffic-related condition, other types of conditions, or some combination thereof. The condition may be used in various applications, such as human pose lifting, skeleton based human action recognition, 3D mesh reconstruction, traffic navigation, social network analysis, recommend system, scientific computing, and so on. An example point grid network is a pose lifting network that processes a grid transformed from a 2D image and outputs features that can be transformed to a 3D image showing a pose of the object.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example CNN

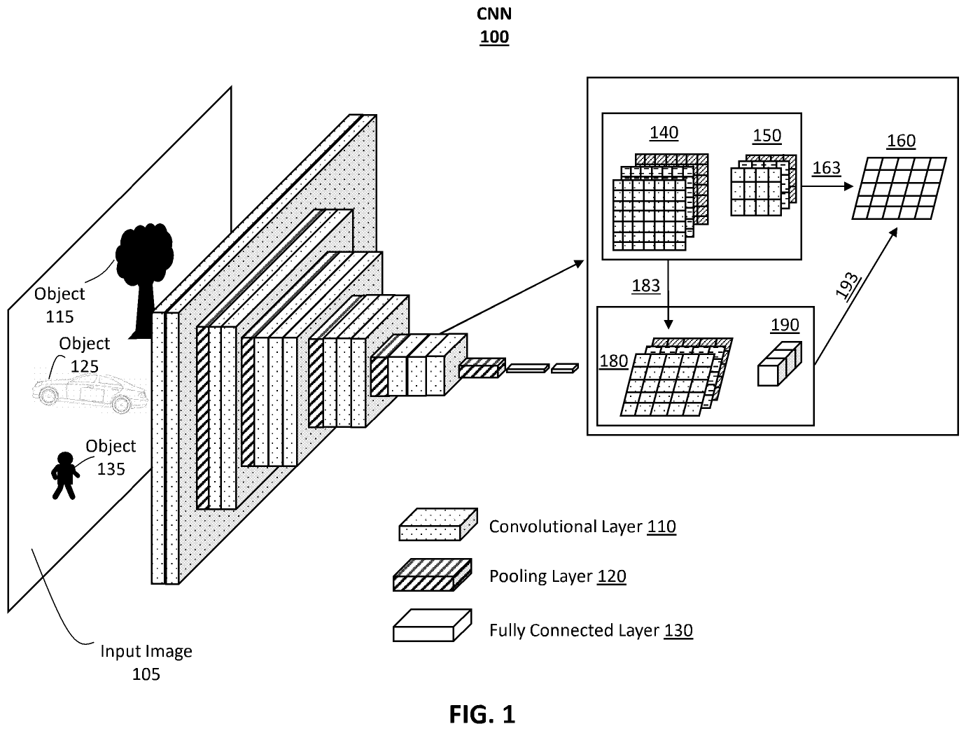

FIG. 1 illustrates an example CNN 100, in accordance with various embodiments. The CNN 100 is trained to receive images and output classifications of objects in the images. In the embodiments of FIG. 1, the CNN 100 receives an input image 105 that includes objects 115, 125, and 135. The CNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the CNN 100 may include fewer, more, or different layers.

The convolutional layers 110 summarize the presence of features in the input image 105. The convolutional layers 110 function as feature extractors. The first layer of the CNN 100 is a convolutional layer 110. In an example, a convolutional layer 110 performs a convolution on an input tensor 140 (also referred to as IFM (input feature map) 140) and a filter 150. As shown in FIG. 1, the IFM 140 is represented by a 7×7×3 3D matrix. The IFM 140 includes 3 input channels, each of which is represented by a 7×7 2D array. The 7×7 2D array includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D array of weights, where the weights are arranged in columns and rows. A kernel can be smaller than the IFM. In the embodiments of FIG. 1, each kernel is represented by a 3×3 2D array. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM (output feature map) 160). The OFM 160 is represented by a 5×5 2D array. The 5×5 2D array includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D array of output elements. As such, the 2D output array (i.e., the OFM 160) from the standard convolution 163 is referred to an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D array. The 5×5 2D array includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kerneled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The CNN 100 includes 16 convolutional layers 110. In other embodiments, the CNN 100 may include a different number of convolutional layers.

The pooling layers 120 down-sample feature maps generated by the convolutional layers, e.g., by summarizing the presents of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes 3 probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example Point Grid System

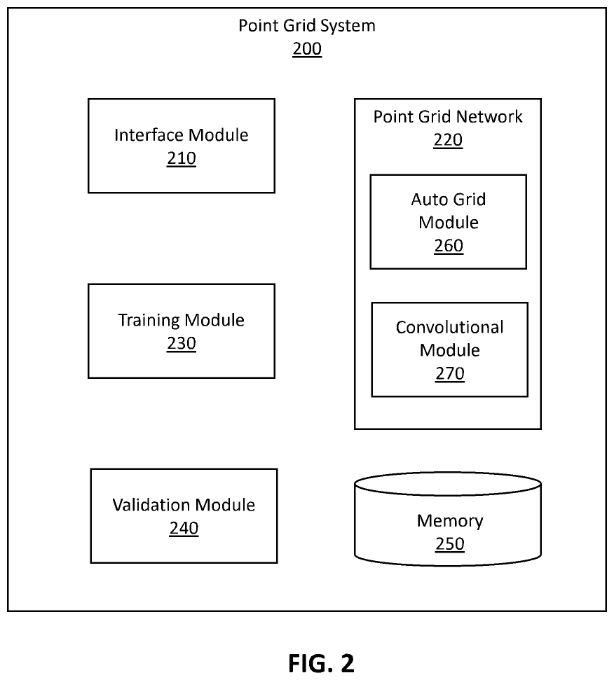

FIG. 2 is a block diagram of a point grid system 200, in accordance with various embodiments. The point grid system 200 facilitates convolutions on graph-structured data. The point grid system 200 includes an interface module 210, a point grid network 220, a training module 230, a validation module 240, and a memory 250. In other embodiments, alternative configurations, different or additional components may be included in the point grid system 200. For instance, the point grid system 200 may include more than one point grid networks.

Further, functionality attributed to a component of the point grid system 200 may be accomplished by a different component included in the point grid system 200 or by a different system.

The interface module 210 facilitates communications of the point grid system 200 with other systems. In some embodiments, the interface module 210 establishes communications between the point grid system 200 with an external database to receive graph-structured data that can be used for training the point grid network 220 or for inference of the point grid network 220. The external database may be an image gallery that stores a plurality of images, such as 2D images, 3D images, etc. The interface module 210 may support the point grid system 200 to distribute the point grid network 220 to other systems, e.g., computing devices configured to apply the point grid network 220 to perform tasks. The computing devices may be an edge device, a client device, and so on. The interface module 210 may also support the point grid system 200 to distribute output of the point grid network 220 to other systems.

The point grid network 220 performs machine learning tasks with graph-structured data. A machine learning task is a task of making an inference. The inference is a process of running available data (e.g., graph-structured data) into the point grid network 220 to generate an output. The output provides a solution to a problem or question that is being asked. The point grid network 220 can perform machine learning tasks for various applications, including applications that conventionally rely on graph-structured data, such as 2D-to-3D human pose lifting, skeleton based human action recognition, skeleton based human gait recognition, landmarks-based facial expression recognition, joints-based hand gesture recognition, 3D mesh reconstruction, traffic navigation, social network analysis, recommend system, and scientific computing.

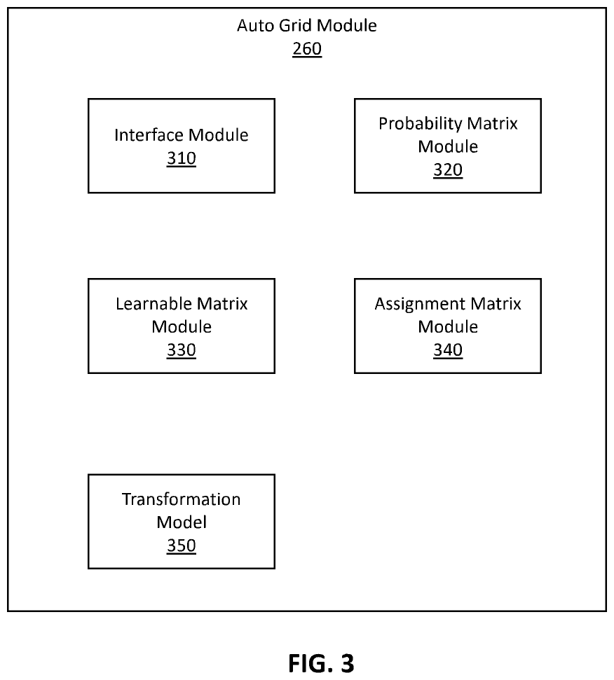

In the embodiments of FIG. 2, the point grid network 220 includes an auto grid module 260 and a convolutional module 270. The auto grid module 260 is configured to transform a graph-structured data sample to a grid-structured data sample by applying a transformation function on the graph-structured data sample and an assignment matrix. The assignment matrix includes a plurality of assignment elements arranged in an array, e.g., an array including columns and rows. The values of the assignment elements may be zeros and ones. The auto grid module 260 may generate assignment matrix from a learnable matrix. The learnable matrix may have the same size as the assignment matrix, but the values of the elements in the learnable matrix can be any value in the range from zero to one. Also, the values of the elements in the learnable matrix are determined by training the point grid network 220. The auto grid module 260 may be a layer in the point grid network 220. Certain aspects of the auto grid module 260 are described below in conjunction with FIG. 3.

The grid-structured data sample, which is an output of the auto grid module 260, can be fed into the convolutional module 270. The convolutional module 270 may include a plurality of convolutional layer. In some embodiments, the convolutional module 270 also includes other layers, such as pooling layer, fully connected layer, other types of hidden layer, or some combination thereof. An embodiment of the convolutional module 270 may be the CNN 100 described above in conjunction with FIG. 1. The convolutional module 270 can process the grid-structured data sample to make a determination, e.g., pose estimation. A convolutional layer of the convolutional module 270 may extract features from the grid-structured data sample or from an output of another layer of the convolutional network. In an embodiment, the convolutional layer may generate variants of the grid-structured data sample and extracts features based on the variants. A variant of the grid-structured data sample may include some or all of the nodes in the grid-structured data sample but has a different structure from the grid-structured data sample or the other variants. The output of the convolutional network may be grid-structured data, such as a grid-structured feature map.

The training module 230 trains the point grid network 220, which performs machine learning tasks with graph-structured data samples. In a process of training the point grid network 220, the training module 230 may form a training dataset. The training dataset includes training samples and ground-truth labels. The training samples may be graph-structured data samples. Each training samples may be associated with one or more ground-truth labels. A ground-truth label of a training sample may be a known or verified label that answers the problem or question that the point grid network 220 will be used to answer. In an example where the point grid network 220 is used to estimate pose, a ground-truth label may indicate a ground-truth pose of an object in the training sample. The ground-truth label may be a numerical value that indicates a pose or a likelihood of the object having a pose.

In some embodiments, the training module 230 may also form validation datasets for validating performance of the point grid network 220 after training by the validation module 240. A validation dataset may include validation samples and ground-truth labels of the validation samples. The validation dataset may include different samples from the training dataset used for training the point grid network 220. In an embodiment, a part of a training dataset may be used to initially train the point grid network 220, and the rest of the training dataset may be held back as a validation subset used by the validation module 240 to validate performance of the point grid network 220. The portion of the training dataset not including the validation subset may be used to train the point grid network 220.

The training module 230 also determines hyperparameters for training the point grid network 220. Hyperparameters are variables specifying the training process. Hyperparameters are different from parameters inside the point grid network 220 (“internal parameters,” e.g., adaptive assignment matrix, weights for convolution operations, etc.). In some embodiments, hyperparameters include variables determining the architecture of the point grid network 220, such as number of hidden layers, etc. Hyperparameters also include variables which determine how the point grid network 220 is trained, such as batch size, number of epochs, etc. A batch size defines the number of training samples to work through before updating the parameters of the point grid network 220. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the internal parameters of the point grid network 220. An epoch may include one or more batches. The number of epochs may be 15, 150, 500, 1500, or even larger.

The training module 230 defines the architecture of the point grid network 220, e.g., based on some of the hyperparameters. The architecture of the point grid network 220 includes an input layer, an output layer, and a plurality of hidden layers. The input layer of the point grid network 220 may include tensors (e.g., a multi-dimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the point grid network 220 convert the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolutional layers. A fully connected layer involves weights, biases, and neurons. It connects neurons in one layer to neurons in another layer. It is used to classify images between different category by training.

In the process of defining the architecture of the point grid network 220, the training module 230 also adds an activation function to a hidden layer or the output layer. An activation function of a layer transforms the weighted sum of the input of the layer to an output of the layer. The activation function may be, for example, a ReLU activation function, a tangent activation function, or other types of activation functions. After the training module 230 defines the architecture of the point grid network 220, the training module 230 inputs the training dataset into the point grid network 220. The training module 230 modifies the internal parameters of the point grid network 220 to minimize the error between labels of the training samples that are generated by the point grid network 220 and the ground-truth labels. In some embodiments, the training module 230 uses a cost function or loss function to minimize the error.

The training module 230 may train the point grid network 220 for a predetermined number of epochs. The number of epochs is a hyperparameter that defines the number of times that the DL algorithm will work through the entire training dataset. One epoch means that each sample in the training dataset has had an opportunity to update the internal parameters of the point grid network 220. After the training module 230 finishes the predetermined number of epochs, the training module 230 may stop updating the internal parameters of the point grid network 220, and the point grid network 220 is considered trained.

The validation module 240 verifies accuracy of the point grid network 220 after the point grid network 220 is trained. In some embodiments, the validation module 240 inputs samples in a validation dataset into the point grid network 220 and uses the outputs of the point grid network 220 to determine the model accuracy. In some embodiments, a validation dataset may be formed of some or all the samples in the training dataset. Additionally or alternatively, the validation dataset includes additional samples, other than those in the training sets. In some embodiments, the validation module 240 determines may determine an accuracy score measuring the precision, recall, or a combination of precision and recall of the DNN. The validation module 240 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 240 may compare the accuracy score with a threshold score. In an example where the validation module 240 determines that the accuracy score is lower than the threshold score, the validation module 240 instructs the training module 230 to re-train the point grid network 220. In one embodiment, the training module 230 may iteratively re-train the point grid network 220 until the occurrence of a stopping condition, such as the accuracy measurement indication that the point grid network 220 may be sufficiently accurate, or a number of training rounds having taken place.

The memory 250 stores data received, generated, used, or otherwise associated with the point grid system 200. For example, the memory 250 stores the datasets used by the training module 230 and validation module 240. The memory 250 may also store data generated by the training module 230 and validation module 240, such as the hyperparameters for training the point grid network 220, internal parameters of the point grid network 220 (e.g., weights for convolution, values of tunable parameters of FALUs), etc. In the embodiment of FIG. 2, the memory 250 is a component of the point grid system 200. In other embodiments, the memory 250 may be external to the point grid system 200 and communicate with the point grid system 200 through a network.

### Example Auto Grid Module

FIG. 3 is a block diagram of an auto grid module 260, in accordance with various embodiments. The auto grid module 260 may be part of a point grid network, e.g., the point grid network 220 or 300. The auto grid module 260 transforms graph-structured data to grid-structured data. The auto grid module 260 includes an interface module 310, a probability matrix module 320, a learnable matrix module 330, an assignment matrix module 340, and a transformation module 350. In other embodiments, alternative configurations, different or additional components may be included in the auto grid module 260. Further, functionality attributed to a component of the auto grid module 260 may be accomplished by a different component included in the auto grid module 260 or by a different system.

The interface module 310 facilitates communication of the auto grid module 260 with other modules, systems, or devices. In some embodiments, the interface module 310 may receive graph-structured data samples from an input layer of point grid network or an external system associated with the point grid network. A graph-structured data sample may be a graph representation of an object. The object may be a person, face, hand, structure, building, animal, plant, tree, and so on. A graph-structured data sample can be represented as a graph G={V, E} with the nodes V storing node features and the edges E defining node connections. The degree of the graph nodes depends on the connected edges E, which leads to irregular neighborhoods of local regions. In some embodiments, the graph G may have j nodes and each node has C feature channels and the graph may represented as G∈R^{J×C}.

The interface module 310 may also transmit grid-structured data samples, which are generated from the graph-structured data samples to a convolutional network in the point grid network for the convolutional network to extract features from the grid-structured data samples. A grid-structured data sample may be a weave-like grid representation. The weave-like grid may be represented as a grid D∈R^{H×P×C}, which has a spatial size of H×P.

The probability matrix module 320 generates a probability matrix. The probability matrix may include a plurality of elements arranged in an array, e.g., an arrange including columns and rows. The probability matrix may be a continuous distribution of probabilities. The probability matrix may be represented as S^{prob}∈R^{HP×J}. An element

$${S}_{i j}^{p r o b}$$

in the probability matrix S^{prob} indicates a probability of assigning a graph node Gⱼ of the graph G to a id node Dᵢ of the grid D. In some embodiments, the value of the element

$${S}_{i j}^{p r o b}$$

is in a range from 0 to 1, where 0 indicates that the probability of assigning the graph node Gⱼ to the grid node Dᵢ is 0%, versus 1 indicates that the probability of assigning the graph node Gⱼ to the grid node Dᵢ is 100%.

The learnable matrix module 330 generates a learnable matrix from the probability matrix. In some embodiments, the learnable matrix module 330 generates the learnable matrix by adding a noise matrix to the probability matrix. The noise matrix can assist to resample the learnable matrix from the continuous distribution. In an embodiment, the noise matrix is a Gumbel-Softmax distribution, which can interpolate between discrete one-hot-encoded distributions (e.g., distributions in a matrix including one-hot vectors) and continuous distributions (e.g., distribution in a matrix including continuous vectors). The noise matrix may parameterize a multinomial distribution on a one-hot-encoding multi-dimensional vector in terms of a continuous multi-dimensional vector. The noise matrix may also stabilize the training optimization, attaining good solutions. By introducing the noise matrix, the learnable matrix module 330 can explore different grid encoding proposals, which facilitates the auto grid module 260 to search for an effective semantic grid transformation.

The generation of the learnable matrix can be denoted as:

$${S}^{l e a r n} = {S}^{p r o b} + ε$$

where S^{learn} is the learnable matrix, ε∈R^{HP×J} is the noise matrix that assists to resample the learnable matrix S^{learn} from the continuous distribution S^{prob}v. The learnable matrix may have the same size as the probability matrix, e.g., the same number of columns and the same number of rows. The value of an element

$${S}_{i j}^{l e a r n}$$

in the learnable matrix S^{learn} can be determined by a process of training the point grid network 220, during which the values of at least some of the elements in the probability matrix S^{learn} are adjusted at least once. The value of an element of the learnable matrix S^{learn} can be adjusted through continuous gradient approximation.

The assignment matrix module 340 generates an assignment matrix from the learnable matrix after the point grid network 220 is trained. In some embodiments, the assignment matrix module 340 applies a discretization operation on the learnable matrix to generate the assignment matrix. The learnable matrix S may be defined as the highest probability response per row on the learnable matrix S^{learn}. The assignment matrix module 340 performs discretization operation on all the rows of the learnable matrix S^{learn}, the result of which is the assignment matrix S. The discretization operation can be represented as:

$${S}_{i} = onehot ( arg {max}_{j} {S}_{ij}^{soft} )$$

where argmax is an operation that finds the element that gives the maximum value from a target function, i denotes a column index, j denotes a row index, Sᵢ is an element having a value of one in the j row of the assignment matrix S. Sᵢ has the same column index as the element having the largest value in the j row of the learnable matrix S^{learn}. The values of all the other elements in the j row of the learnable matrix S^{learn} are zero.

Each row in the assignment matrix S is converted from a corresponding row in the learnable matrix S^{learn}. The number of elements in each row in the assignment matrix S may be the same as the number of elements in the corresponding row in the learnable matrix S^{learn}. Each row in the learnable matrix S^{learn} may be a continuous vector and the values of the elements in the continuous vector may be any values in a predetermined range, e.g., 0 to 1. Each row in the assignment matrix S may be a one-hot vector. The one-hot vector includes a group of bits among which the combinations of values are only those with a single high (e.g., 1) bit and all the others a low bit (e.g., 0). In an example, the elements of the assignment matrix S have values of 0 and 1. In each row of the assignment matrix S, one element has the value of 1 and the other elements have the value of zero. The assignment matrix S can be used to convert graph-structured data samples to grid-structured data samples.

The transformation module 350 transforms graph-structured data samples to grid-structured data samples based on the assignment matrix generated by the assignment matrix module 340. The transformation module 350 may apply a transformation function on the assignment matrix and a graph-structured data sample to generate the corresponding grid-structured data sample. The transformation process is an auto semantic grid transformation, which may be represented as:

$$D = ϕ ( G ) = reshape ( S \times G ) , \qquad ( 2 )$$

where ϕ denotes the transformation function for mapping node indices, G∈R^{J×C} denotes the input graph-structured data sample having j graph nodes and each graph node has C feature channels, D∈R^{H×P×C} denotes the output of a grid-structured data sample with a spatial size of H×P, S∈{0,1}^{HP×J} denotes the assignment matrix mapping graph node indices, reshape (⋅) operation rearranges the output of S×G into an H×P grid.

The values of the elements in the assignment matrix S determines which grid node in the grid-structured data sample D will filled with which graph node in the graph-structured data sample G. For instance, a grid element Dₚ, p∈[1, HP] will be filled by a particular graph node Gⱼ, j∈[1,J] if S_{p,j}=1, versus the grid element Dₚ, p∈[1, HP] will be not filled by any graph node if S_{p,j}=0.

### Example Process of Training Point Grid Network

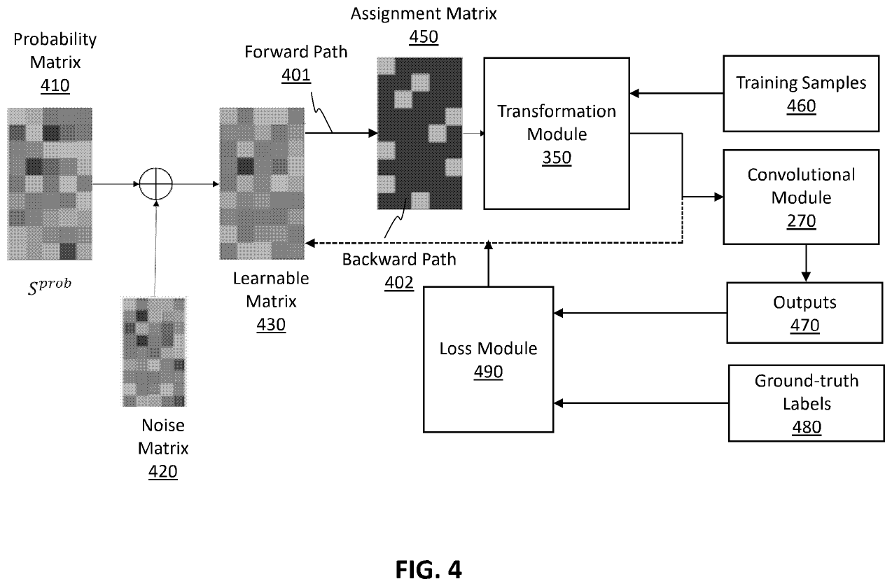

FIG. 4 illustrates a process of training the point grid network 220, in accordance with various embodiments. The training process may be performed by the training module 230 in FIG. 2. In FIG. 4, a probability matrix 410 is combined with a noise matrix 420, which generates a learnable matrix 430. The learnable matrix 430 is converted to an assignment matrix 450. The generation of the probability matrix 410, noise matrix 420, learnable matrix 430, and assignment matrix 450 can be conducted by the auto grid module 260 in FIGS. 2 and 3.

The assignment matrix 450 and training samples 460 are input into the transformation module 350. The training samples are graph-structured data samples. The transformation module 350 applies a transformation function on each training sample and the assignment matrix 450 to generate a grid-structured data sample. In the transformation process, the transformation function can assign a graph node in the training sample to a grid node in a grid structure based on the assignment matrix 450. The grid-structured data sample is formed after one or more graph nodes are assigned. The transformation module 350 transmits the grid-structured data samples converted from the training samples 460 into the convolutional module 270. The convolutional module 270 can process the grid-structured data samples and generates outputs 470. Each output 470 may correspond to a different grid-structured data sample.

The outputs 470 and ground-truth labels 480 of the training samples 460 are provided to a loss module 490. A training sample 460 may have one or more ground-truth labels 480. The training samples 460 and ground-truth labels 480 may be from a training set generated by the training module 230. The loss module 490 can determine differences between the outputs 470 and ground-truth labels 480. For instance, the loss module 490 may determine a different between each output and the corresponding ground-truth label. The loss module 490 may determine a loss by aggregating the differences. In some embodiments, the loss module 490 may use a loss function to adjust parameters in the learnable matrix 430 and the convolutional module 270 to minimize the loss. Parameters in the learnable matrix 430 are values of the elements in the learnable matrix 430. Parameters in the convolutional module 270 include values of weights in the convolutional filter used by the convolutional module 270. Every time the learnable matrix 430 is updated (e.g., the value of at least one element in the learnable matrix 430 is adjusted), a new assignment matrix is generated and can be used in the next epoch or batch of the training process.

The path of generating the assignment matrix 450 and inputting the assignment matrix 450 and training samples 460 into the transformation module 350 and convolutional module 270 is a forward path 401. The path of using loss to adjust the learnable matrix 430 is a backward path 402. In the backward path 402 of the training process, continuous gradient approximation is used to update learnable matrix 430 instead of the assignment matrix 450. A benefit of updating the learnable matrix 430, as opposed to directly updating the assignment matrix 450, is that the learnable matrix 430 can be adjusted based on continuous gradient approximation, versus the assignment matrix 450 has discrete values (e.g., 0 and 1) and cannot be adjusted based on continuous gradient approximation. The discretization operation that converts the learnable matrix 430 to the assignment matrix 450 has cut off the backward continuous gradient flow during the training process.

In the embodiments of FIG. 4, the learnable matrix 430 and convolutional filter are trained together in the same learning process. In other embodiments, the learnable matrix 430 and convolutional filter may be trained in separate learning processes. For instance, the learnable matrix 430 may be trained first, then the convolutional filter is trained.

### Example Inference of Point Grid Network

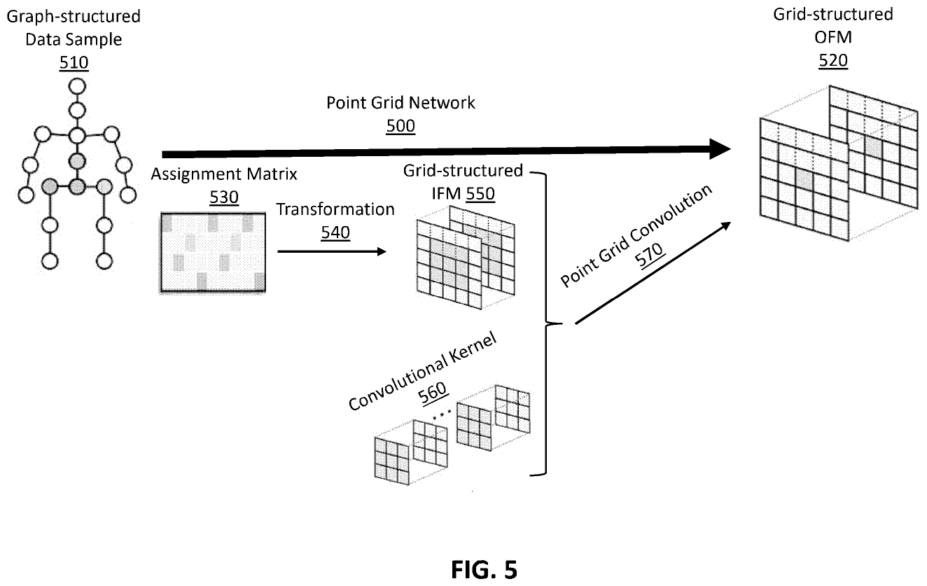

FIG. 5 illustrates an inference of a point grid network 500, in accordance with various embodiments. The point grid network 500 may be an embodiment of a part or the whole point grid network 220 in FIG. 2. In the inference illustrated in FIG. 5, the point grid network 220 receives a graph-structured data sample 510. For purpose of illustration, the graph-structured data sample 510 is a graph representation of a person. The point grid network 500 processes the graph-structured data sample 510 and outputs a grid-structured OFM 520. The grid-structured OFM 520 may include a plurality of elements arranged in a grid structure in each channel. The grid structure may be a weave-like grid structure. The grid-structured OFM 520 may be further processed to make a determination, e.g., to estimate a pose of the person.

The inference of the point grid network 500 in FIG. 5 includes 2 steps: a transformation 540 and a point grid convolution 570. The transformation 540 is applied on the graph-structured data sample 510 and an assignment matrix 530 and outputs a grid-structured IFM 550. The transformation 540 may be performed by the transformation module 350 in FIG. 3.

The point grid convolution 570 is a convolution on grid-structured data. The point grid convolution 570 may include multiply-accumulate (MAC) operations on the grid-structured IFM 550 and a convolutional filter 560. A result of the MAC operations is the grid-structured OFM 520. The point grid convolution 570 may be a regular convolution, such as the convolution described above in conjunction with FIG. 1. The grid-structured IFM 550 includes a plurality of input channels. Each channel may include an array including a number of rows and a number of columns. The filter 560 includes a number of filters. The grid-structured OFM 520 includes a plurality of output channels. The number of output channels in the grid-structured OFM 520 may equal the number of filters in the filter 560.

In some embodiments, the point grid convolution 570 may be formulated as

$${D}^{o u t} = W * {D}^{i n}$$

where Dⁱⁿ∈R^{H×P×C} in denotes the grid-structured IFM 550 with a spatial size of H×P and Cᵢₙ channels, W∈R^{K×K×C}^{ᵢₙ}^{×C}^{ₒᵤₜ} denotes the filter 560 having Cₒᵤₜ filters with a spatial size of K×K, e.g., K={1, 3, 5 . . . } based on spatial size of the grid-structured IFM 550, * denotes convolution operation, and D^{out}∈R^{H×P×C}^{ₒᵤₜ} denotes the grid-structured OFM 520 with a spatial size of H×P and Cₒᵤₜ channels.

The point grid convolution 570 may be performed by a convolutional layer (e.g., the first convolutional layer) of a point grid network, such as the point grid network 220 in FIG. 2. The grid-structured OFM 520 is also grid-structured data. The grid-structured OFM 520 may be further processed, e.g., through an activation function, another convolution, or other functions. In some embodiments, padding is performed before the point grid convolution 570, which can enable the grid-structured IFM 550 and the grid-structured OFM 520 to have the same spatial size, e.g., the same number of rows and same number of columns per channel. The grid-structured IFM 550 and the grid-structured OFM 520 may have different numbers of channels. In other embodiments, the grid-structured IFM 550 and the grid-structured OFM 520 have different spatial sizes.

### Example Semantic Grid Transformation by Point Grid Network

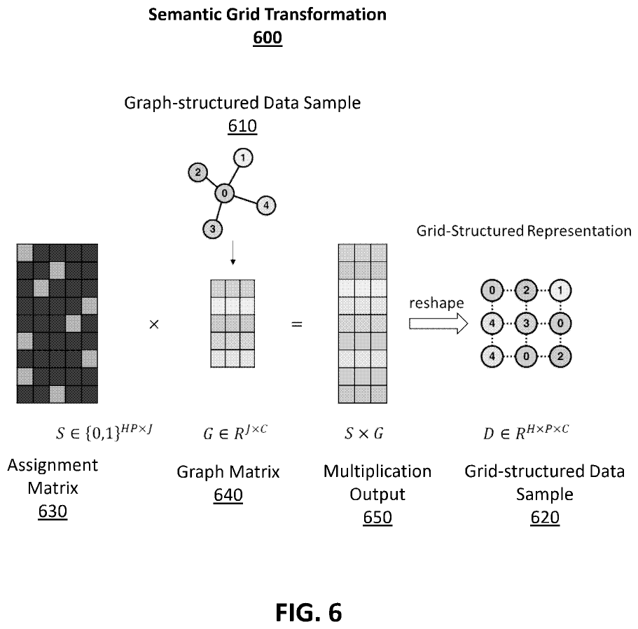

FIG. 6 illustrates an example semantic grid transformation 600 by a point grid network, in accordance with various embodiments. The semantic grid transformation is a transformation of a graph-structured data sample 610 to a grid-structured data sample 620 The transformation may be performed by the auto grid module 260 in FIG. 1. An assignment matrix 630 has HP rows and J columns. In the embodiments of FIG. 6, HP equals 9 and J equals 5. Each element in the assignment matrix 630 has a value of 0 or 1. The graph-structured data sample 610 is represented by a graph matrix 640 that has C channel and J graph nodes in each channel. In the embodiments of FIG. 6, C equals 3. The assignment matrix 630 is multiplied with the graph matrix 640, the result of the multiplication is a multiplication output 650, which has 9 rows and 3 columns. Then the multiplication output 650 is rearranged and converted to the grid-structured data sample 620. The grid-structured data sample 620 includes 3 channels. In each channel, there are H rows and P columns, where H equals 3 and P equals 3. As shown in FIG. 6, the grid-structured data sample 620 has a structure similar to the IFM 140 in FIG. 1 and therefore, can be processed by convolutional layers as an input tensor.

### Example Convolution by Point Grid Network

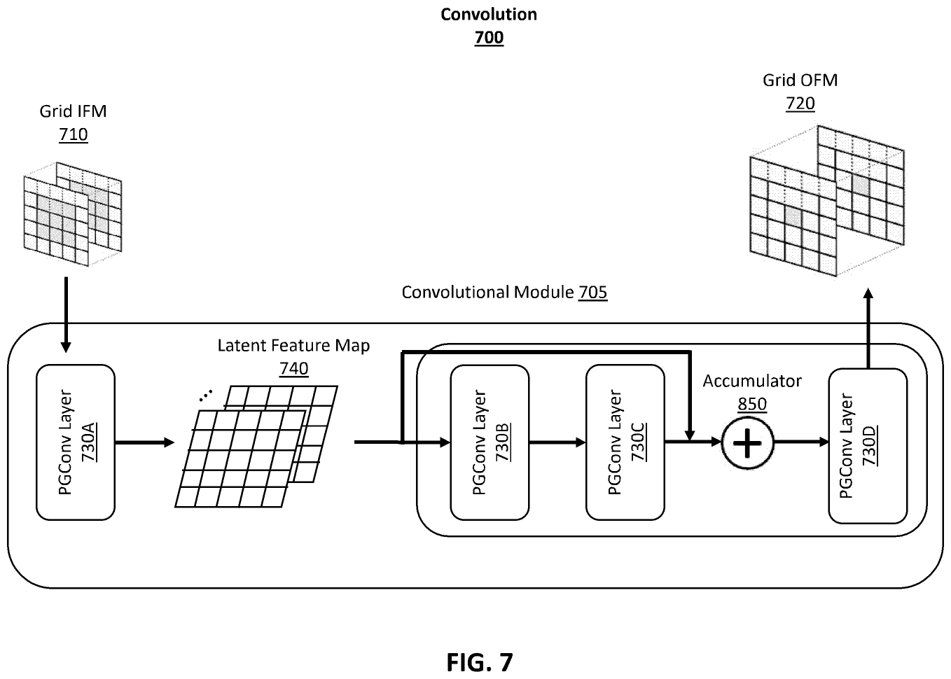

FIG. 7 illustrates an example convolution 700 by a point grid network, in accordance with various embodiments. The point grid network may be an example of the point grid network 220 in FIG. 2. The point grid network can receive a graph-structured data sample and convert the graph-structured data sample into grid-structured data. In some embodiments, the grid-structured data is a grid IFM 710 shown in FIG. 7, e.g., through a transformation such as the semantic grid transformation 600 in FIG. 6. The grid IFM 710 is fed into a convolutional module 705. The convolutional module 705 can process the grid IFM 710 and outputs a grid OFM 720. The grid IFM 710 and grid OFM 720 are both grid-structured tensors. The convolutional module 705 may be an example of the convolutional module 270 in FIG. 2. In other embodiments, the grid IFM 710 is a result of applying padding on the grid-structured data. The padding can facilitate that the grid IFM 710 and the grid OFM 720 have the same spatial size.

As shown in FIG. 7, the convolutional module 705 includes multiple point grid convolutional (“PGConv”) layers 730A-630D, which are collectively referred to as PGConv layers 730 or PGConv layer 730. A PGConv layer 730 is a convolutional layer. Each PGConv layer 730 performs a point grid convolution. The PGConv layers 730 are arranged in a sequence. A PGConv layer 730 may receive the output of the preceding PGConv layer 730 and performs a point grid convolution on the output of the preceding PGConv layer 730. In the embodiments of FIG. 7, the first PGConv layer 730A receives the grid IFM 710 and generates a latent feature map 740. The latent feature map 740 are “hidden” features, as opposed to observed features, such as the grid OFM 720. Each of the PGConv layers 730A-C generates a latent feature map. The spatial size of the latent feature maps may be fixed throughout the lifting process.

In addition to the PGConv layers 730, the convolution module 705 also includes an accumulator 750 that accumulates the latent feature map 740 and the output of the PGConv layer 730C. In other embodiments, the convolutional module 705 may include other functions for performing other operations that perform additional operation in the inference, such as activation, pooling, etc.

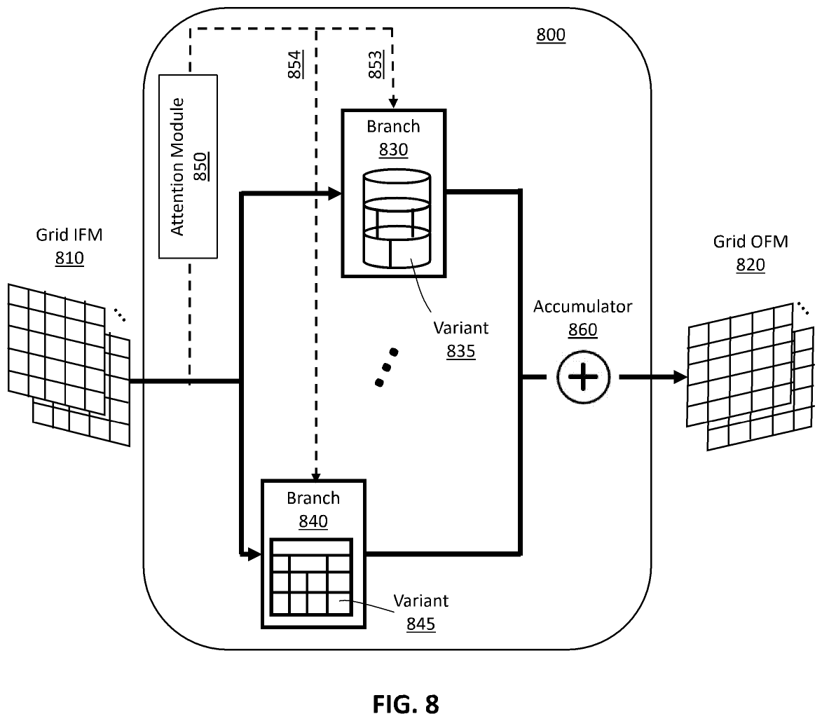

FIG. 8 illustrates an example convolutional layer in a point grid network, in accordance with various embodiments. The point grid network may be an example of the point grid network 220 in FIG. 2. The convolutional layer is a PGConv layer 800 that includes multiple branches. The PGConv layer 800 may be an embodiment of a PGConv layer 730 in FIG. 7. As shown in FIG. 8, the PGConv layer 800 receives a grid IFM 810 and output a grid OFM 820. The grid IFM 810 may be the grid IFM 710, the latent feature map 740, or a different latent feature map. The grid OFM 820 may be the latent feature map 740, a different latent feature map, or the grid OFM 720.

The PGConv layer 800 includes multiple branches. For purpose of simplicity and illustration, FIG. 8 shows 2 branches 830 and 840. In other embodiments, the PGConv layer 800 may include more branches. The branches 830 and 840 generate variants 835 and 845, respectively. The variants 835 and 845 are also grid-structured data. The variants 835 and 845 have different structures but may have same graph nodes. For purpose of illustration, the variant 835 has a cylindrical structure, versus variant 845 has a rectangular structure. In other embodiments, a variant of the grid IFM 810 may have other shapes, e.g., donut shape, square, bucket shape, pipe shape, and so on. The branches 830 and 840 may use different padding approaches to form the different variants. Padding, in some embodiments, can ensure that the grid IFM and grid OFM have the same spatial size, e.g., the same number of rows and same number of columns per channel, but the grid IFM and grid OFM may have different numbers of channels. Each branch may extract features from its variant.

The PGConv layer 800 also includes an attention module 850 that generates scalar filters for the branches 830 and 840. For instance, the attention module 850 may generate a scalar filter 853 for the branch 830 and a scalar filter 854 for the branch 840 based on the grid IFM 810. The branch 830 may perform an elementwise multiplication operation on the scalar filter 853 and a convolutional filter for the branch 830. The branch 840 can further use the result of the elementwise multiplication operation and the variant 835 to perform a convolutional operation. Similarly, the branch 840 may perform an elementwise multiplication operation on the scalar filter 854 and a convolutional filter, and further use the result of the elementwise multiplication operation and the variant 845 to perform a convolutional operation. The introduction of the scalar filters 853 and 854 can augment adaptiveness of the convolutional operations to the input of the PGConv layer 800. Conventionally, the internal parameters for convolutional operations are convolutional filters, values in which are determined during the training of the point grid network and do not change with change in the grid IFM 810. In contrast, the internal parameters of the convolutional operations by the PGConv layer 800 further include the scalar filters 853 and 854, values of which are determined based on the grid IFM 810. In other words, the internal parameters of the convolutional operations by the PGConv layer 800 can change as the grid IFM 810 changes. Such convolutional operations are dynamic. Through the elementwise multiplication operation, the convolutional filter can be augmented with flexible adaptiveness.

In some embodiments, the attention module 850 applies an attention function on the grid IFM 810, and the attention function returns the scalar filters 853 and 854. The attention function may be determined during the training of the point grid network. For instance, the attention function includes one or more parameters, the values of which are determined through the training of the point grid network. In some embodiments, the PGConv layer 800 does not include the attention module 850.

As shown in FIG. 8, the PGConv layer 800 also includes an accumulator 860 that accumulates features generated by the branches 830 and 840. The result of the accumulation may be the grid OFM 820. The grid OFM 820 may be provided to another PGConv layer for further point grid convolution or be output by the point grid network and be used to generate a 3D graph representation of an estimated pose.

### Example Grid Lifting Network

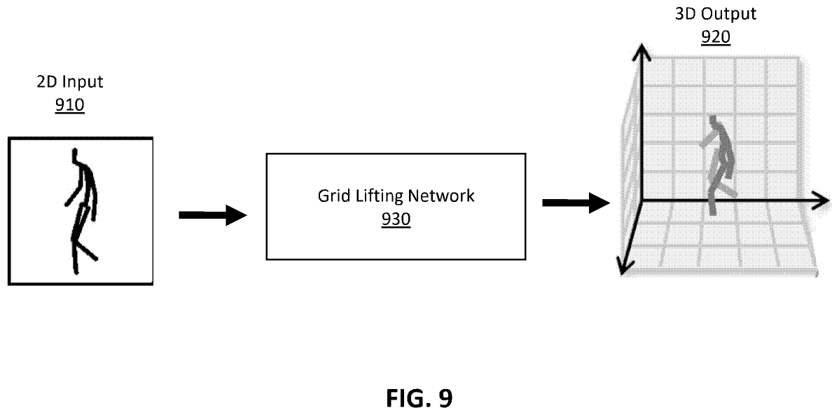

FIG. 9 illustrates an example 3D pose estimation by a grid lifting network 930, in accordance with various embodiments. The grid lifting network 930 may be an embodiment of the point grid network 220. The grid lifting network 930 has been trained to process graph-structured data samples to estimate 3D poses. The grid lifting network 930 may be trained with a training dataset that includes graph-structured data samples and ground-truth poses illustrated in the graph-structured data samples. In some embodiments, the grid lifting network 930 may be trained by minimizing an error L between the predicted 3D grid pose D_{3D} and the ground-truth

$${D}_{3 D}^{G T}$$

over the training dataset:

$$L = {‖ {D}_{3 D} - {D}_{3 D}^{G T} ‖}^{2}$$

where L denotes a 2-norm distance. During the training of the grid lifting network 930, internal parameters of the grid lifting network 930 are updated to minimize the error. The internal parameters include values of elements in a learnable matrix, weights in convolutional filters, other internal parameters, or some combination thereof.

After the training, the grid lifting network 930 can estimate 3D poses through inferences. An inference is a process of modeling an input. As shown in FIG. 9, the grid lifting network 930 receives a 2D input 910. The 2D input 910 is a graph representation of a person, which may show a 2D pose of the person. The 2D input 920 may be denoted as a graph matrix G. The grid lifting network 920 generates an assignment matrix based on the trained learnable matrix, e.g., through a discretization operation. Then the grid lifting network 930 uses the assignment matrix to assign graph nodes in the 2D input 910 to grid elements in a grid structure and generates a grid representation D of the person. The grid representation is a tensor, an example of which is the input tensor 140 in FIG. 1, and can be processed through one or more convolutional operations.

Through the convolutional operation(s), the grid lifting network 930 can extract features from the grid representation and use the features to generate an 3D output 920. In some embodiments, the grid lifting network 930 may also perform other tensor operations to generate the 3D output 920. The grid lifting network 930 may generate a feature map through the convolutional operation(s) and/or other tensor operations. The feature map is grid-structured. The grid lifting network 930 can convert the grid-structured feature map into the 3D output 920, which is a graph-structured data through an inverse transformation. The inverse transformation may convert D back to G can be easily obtained by mapping grids back into J unique nodes. For repetitive grids, feature merging is applied in the inverse transformation.

The grid lifting network 930 is an example of the point grid network 220. Other examples of the point grid network 220 can be used for different applications or to generate different outputs. An output may be grid-structured data or one or more values, as opposed to a graph-structured data like the 3D output 920.

### Example DL Environment

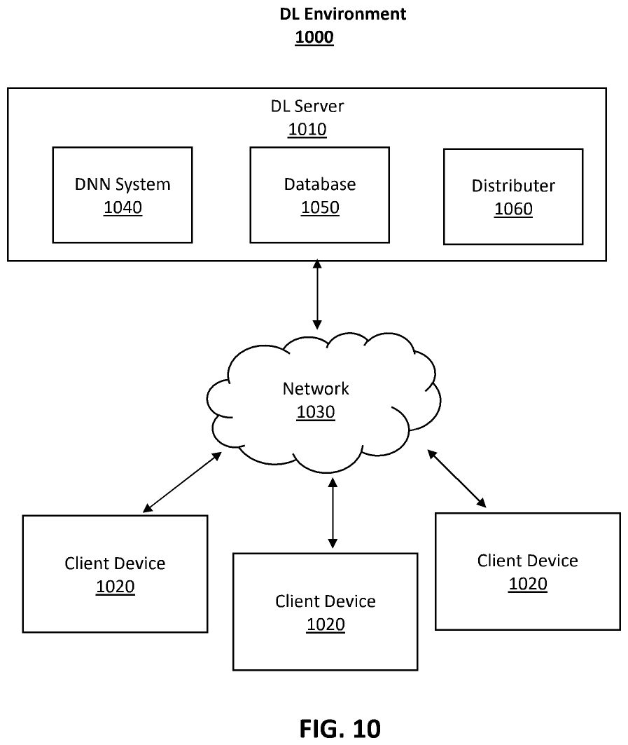

FIG. 10 illustrates a DL environment 1000, in accordance with various embodiments. The DL environment 1000 includes a DL server 1010 and a plurality of client devices 1020 (individually referred to as client device 1020). The DL server 1010 is connected to the client devices 1020 through a network 1030. In other embodiments, the DL environment 1000 may include fewer, more, or different components.

The DL server 1010 trains DL models using neural networks. A neural network is structured like the human brain and consists of artificial neurons, also known as nodes. These nodes are stacked next to each other in 3 types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 1010 can use various types of neural networks, such as point grid networks (e.g., the point grid network 220), CNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 1010 may build DL models specific to particular types of problems that need to be solved. A DL model is trained to receive an input and outputs the solution to the particular problem.

In FIG. 10, the DL server 1010 includes a DNN system 1040, a database 1050, and a distributer 1060. The DNN system 1040 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the CNN 100 described above in conjunction with FIG. 1 or the point grid network 220 described above in conjunction with FIG. 2. An embodiment of the DNN system 1040 is the point grid system 200 described above in conjunction with FIG. 2.

The database 1050 stores data received, used, generated, or otherwise associated with the DL server 1010. For example, the database 1050 stores a training dataset that the DNN system 1040 uses to train DNNs. In an embodiment, the training dataset is an image gallery that can be used to train a DNN for classifying images, estimating poses, and so on. The training dataset may include data received from the client devices 1020. As another example, the database 1050 stores hyperparameters of the neural networks built by the DL server 1010.

The distributer 1060 distributes DL models generated by the DL server 1010 to the client devices 1020. In some embodiments, the distributer 1060 receives a request for a DNN from a client device 1020 through the network 1030. The request may include a description of a problem that the client device 1020 needs to solve. The request may also include information of the client device 1020, such as information describing available computing resource on the client device. The information describing available computing resource on the client device 1020 can be information indicating network bandwidth, information indicating available memory size, information indicating processing power of the client device 1020, and so on. In an embodiment, the distributer may instruct the DNN system 1040 to generate a DNN in accordance with the request. The DNN system 1040 may generate a DNN based on the information in the request. For instance, the DNN system 1040 can determine the structure of the DNN and/or train the DNN in accordance with the request.

In another embodiment, the distributer 1060 may select the DNN from a group of pre-existing DNNs based on the request. The distributer 1060 may select a DNN for a particular client device 1020 based on the size of the DNN and available resources of the client device 1020. In embodiments where the distributer 1060 determines that the client device 1020 has limited memory or processing power, the distributer 1060 may select a compressed DNN for the client device 1020, as opposed to an uncompressed DNN that has a larger size. The distributer 1060 then transmits the DNN generated or selected for the client device 1020 to the client device 1020.

In some embodiments, the distributer 1060 may receive feedback from the client device 1020. For example, the distributer 1060 receives new training data from the client device 1020 and may send the new training data to the DNN system 1040 for further training the DNN. As another example, the feedback includes an update of the available computer resource on the client device 1020. The distributer 1060 may send a different DNN to the client device 1020 based on the update. For instance, after receiving the feedback indicating that the computing resources of the client device 1020 have been reduced, the distributer 1060 sends a DNN of a smaller size to the client device 1020.

The client devices 1020 receive DNNs from the distributer 1060 and applies the DNNs to perform machine learning tasks, e.g., to solve problems or answer questions. In various embodiments, the client devices 1020 input images into the DNNs and uses the output of the DNNs for various applications, e.g., visual reconstruction, augmented reality, robot localization and navigation, medical diagnosis, weather prediction, and so on. A client device 1020 may be one or more computing devices capable of receiving user input as well as transmitting and/or receiving data via the network 1030. In one embodiment, a client device 1020 is a conventional computer system, such as a desktop or a laptop computer. Alternatively, a client device 1020 may be a device having computer functionality, such as a personal digital assistant (PDA), a mobile telephone, a smartphone, an autonomous vehicle, or another suitable device. A client device 1020 is configured to communicate via the network 1030. In one embodiment, a client device 1020 executes an application allowing a user of the client device 1020 to interact with the DL server 1010 (e.g., the distributer 1060 of the DL server 1010). The client device 1020 may request DNNs or send feedback to the distributer 1060 through the application. For example, a client device 1020 executes a browser application to enable interaction between the client device 1020 and the DL server 1010 via the network 1030. In another embodiment, a client device 1020 interacts with the DL server 1010 through an application programming interface (API) running on a native operating system of the client device 1020, such as IOS® or ANDROID™.

In an embodiment, a client device 1020 is an integrated computing device that operates as a standalone network-enabled device. For example, the client device 1020 includes display, speakers, microphone, camera, and input device. In another embodiment, a client device 1020 is a computing device for coupling to an external media device such as a television or other external display and/or audio output system. In this embodiment, the client device 1020 may couple to the external media device via a wireless interface or wired interface (e.g., an HDMI cable) and may utilize various functions of the external media device such as its display, speakers, microphone, camera, and input devices. Here, the client device 1020 may be configured to be compatible with a generic external media device that does not have specialized software, firmware, or hardware specifically for interacting with the client device 1020.

The network 1030 supports communications between the DL server 1010 and client devices 1020. The network 1030 may comprise any combination of local area and/or wide area networks, using both wired and/or wireless communication systems. In one embodiment, the network 1030 may use standard communications technologies and/or protocols. For example, the network 1030 may include communication links using technologies such as Ethernet, 10010.11, worldwide interoperability for microwave access (WiMAX), 3G, 4G, code division multiple access (CDMA), digital subscriber line (DSL), etc. Examples of networking protocols used for communicating via the network 1030 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1030 may be represented using any suitable format, such as hypertext markup language (HTML) or extensible markup language (XML). In some embodiments, all or some of the communication links of the network 1030 may be encrypted using any suitable technique or techniques.

### Example Method of Modeling Graph-Structured Data

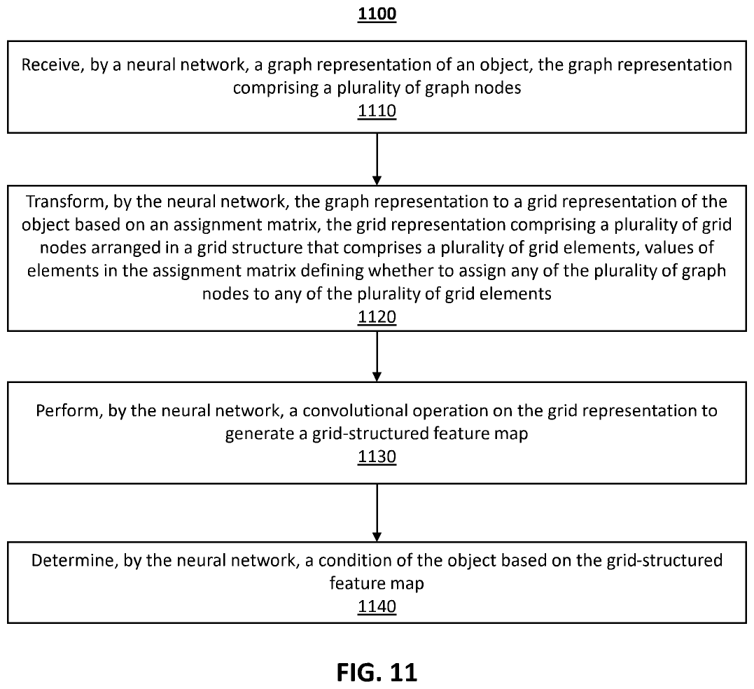

FIG. 11 is a flowchart showing a method 1100 of modeling graph-structured data, in accordance with various embodiments. The method 1100 may be performed by the point grid network 220 in FIG. 2. Although the method 1100 is described with reference to the flowchart illustrated in FIG. 11, many other methods for training a DNN through dense-connection based knowledge distillation may alternatively be used. For example, the order of execution of the steps in FIG. 11 may be changed. As another example, some of the steps may be changed, eliminated, or combined.

The point grid network 220 receives 1110 a graph representation of an object. The graph representation comprising a plurality of graph nodes. The graph representation may be represented by a graph matrix G∈R^{J×C}, which denotes that the graph representation having J nodes and each node has C feature channels.

The point grid network 220 transforms 1120 the graph representation to a grid representation of the object based on an assignment matrix. The grid representation comprising a plurality of grid nodes arranged in a grid structure. The grid structure comprises a plurality of grid elements. Values of elements in the assignment matrix defines whether to assign any of the plurality of graph nodes to any of the plurality of grid elements. In some embodiments, the grid structure is a weave-like grid. The grid structure may have a spatial size of H×P, which denotes H row and P columns, or H columns and P rows. The grid representation may be denoted as a tensor D∈R^{H×P×C}, which has C feature channels, and each channel is a H×P matrix. Such as tensor can be processed with convolution operations, through which features can be extracted from the grid representation. Also, other types of tensor operation (such as pooling operation, elementwise addition,

The point grid network 220 performs s 1130 a convolutional operation on the grid representation to generate a grid-structured feature map. The convolutional operation may be performed on the grid representation and one or more convolutional filters. Values of weights in a convolutional filter are determined in the process of training the point grid network 220. Also, the values of the elements in the assignment matrix are determined through a process of training the neural network. In some embodiments, a learnable matrix in the neural network is trained in the process of training the neural network. Values of elements in the learnable matrix have a continuous distribution.

For instance, training samples are input into the neural network. The training samples include graph representations of objects. The training samples are associated with ground-truth labels indicating ground-truth conditions of objects illustrated in the training samples. The point grid network 220 processes the training samples and output conditions of the objects. The values of the elements in the convolutional filter(s) and the values of the elements in the learnable matrix can be adjusted to minimize a difference between the ground-truth labels and the conditions of the objects. In some embodiments, the values of the elements in the learnable matrix are adjusted with a continuous gradient.

After training the learnable matrix, the learnable matrix is converted to the assignment matrix through a discretization operation. The discretization operation may be performed by the point grid network 220. In the discretization operation, an element in a row in the learnable matrix is identified. The element in the row has a value that is higher than values of other elements in the row. Then the value of the element in the row is changed to a first value, such as 1. Also, the value of the other elements in the row is changed to a second value, such as 0, that is different from the first value. The values of the elements in the assignment matrix have a discrete distribution. The point grid network 220 may multiply the assignment matrix with the graph matrix and then reshape the matrix resulting from the multiplication to generate the grid representation.

In some embodiments, the point grid network 220 performs the convolutional operation by generating a first grid representation and a second grid representation based on the grid representation. The first grid representation and second grid representation may be variants of the grid representation. The first grid representation has a different structure from the second grid representation. The point grid network 220 can generate the grid-structured feature map based on the first grid representation and a second grid representation.

The point grid network 220 determines 1140 a condition of the object based on the grid-structured feature map. For instance, the point grid network 220 may determine a pose of the object based on the grid-structured feature map. The point grid network 220 may further additional convolutional operations or other types of tensor operations on the grid-structured feature map to determine the condition. In some embodiments, the graph representation is a 2D graph representation, and the point grid network 220 can generate a 3D graph representation of the object based on the grid-structured feature map.

### Example Computing Device

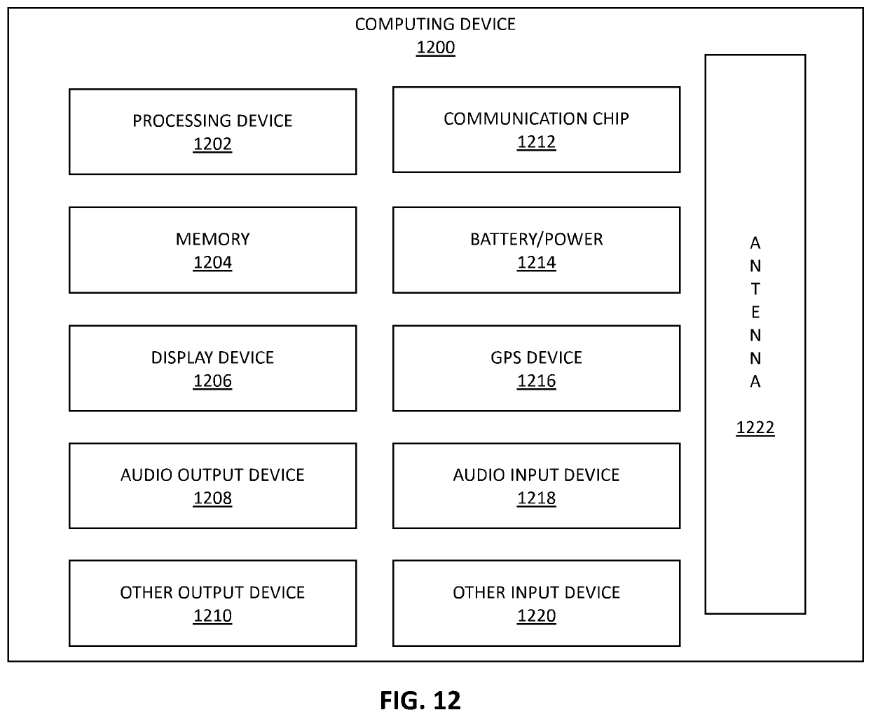

FIG. 12 is a block diagram of an example computing device 1200, in accordance with various embodiments. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1202 may include one or more digital signal processors (DSPs), application-specific ICs (ASICs), CPUs, GPUs, cryptoprocessors (specialized processors that execute cryptographic algorithms within hardware), server processors, or any other suitable processing devices. The computing device 1200 may include a memory 1204, which may itself include one or more memory devices such as volatile memory (e.g., DRAM), nonvolatile memory (e.g., read-only memory (ROM)), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for modeling graph-structured data, e.g., the method 1100 described above in conjunction with FIG. 11 or the operations performed by the point grid system 200 described above in conjunction with FIG. 2. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 1202.13 family), IEEE 1202.16 standards (e.g., IEEE 1202.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 1202.16 compatible Broadband Wireless Access (BWA) networks are generally referred to as WiMAX networks, which is a certification mark for products that pass conformity and interoperability tests for the IEEE 1202.16 standards. The communication chip 1212 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include an other output device 1213 (or corresponding interface circuitry, as discussed above). Examples of the other output device 1213 may include an audio codec, a video codec, a printer, a wired or wireless transmitter for providing information to other devices, or an additional storage device.

The computing device 1200 may include an other input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 1200 may be any other electronic device that processes data.

### Select Examples

The following paragraphs provide various examples of the embodiments disclosed herein.

Example 1 provides a method, the method including receiving, by a neural network, a graph representation of an object, the graph representation including a plurality of graph nodes; transforming, by the neural network, the graph representation to a grid representation of the object based on an assignment matrix, the grid representation including a plurality of grid nodes arranged in a grid structure that includes a plurality of grid elements, values of elements in the assignment matrix defining whether to assign any of the plurality of graph nodes to any of the plurality of grid elements; performing, by the neural network, a convolutional operation on the grid representation to generate a grid-structured feature map; and determining, by the neural network, a condition of the object based on the grid-structured feature map.

Example 2 provides the method of example 1, where the values of the elements in the assignment matrix are determined through a process of training the neural network.

Example 3 provides the method of example 2, where the convolutional operation is performed on the grid representation and a convolutional filter, and values of elements in the convolutional filter are determined in the process of training the neural network.

Example 4 provides the method of example 2 or 3, where the values of the elements in the assignment matrix are determined by training a learnable matrix in the neural network in the process of training the neural network, values of elements in the learnable matrix having a continuous distribution; and after training the learnable matrix, converting the learnable matrix to the assignment matrix through a discretization operation, the values of the elements in the assignment matrix having a discrete distribution.

Example 5 provides the method of example 4, where training the learnable matrix in the neural network in the process of training the neural network includes inputting training samples into the neural network, the training samples including graph representations of objects and associated with ground-truth labels indicating ground-truth conditions of objects illustrated in the training samples, the neural network processing the training samples and outputting conditions of the objects; and updating the values of the elements in the learnable matrix with a continuous gradient to minimize a difference between the ground-truth labels and the conditions of the objects.

Example 6 provides the method of example 4 or 5, where converting the learnable matrix to the assignment matrix through the discretization operation includes identifying an element in a row in the learnable matrix, the element in the row having a value that is higher than values of other elements in the row; changing the value of the element in the row to a first value; and changing the value of the other elements in the row to a second value that is different from the first value.

Example 7 provides the method of example 6, where the first value is 1, and the second value is 0.

Example 8 provides the method of any of the preceding examples, where determining a condition of the object based on the grid-structured feature map includes determining a pose of the object based on the grid-structured feature map.

Example 9 provides the method of any of the preceding examples, where the graph representation is a two-dimensional graph representation, and determining a condition of the object based on the grid-structured feature map includes generating a three-dimensional graph representation of the object based on the grid-structured feature map.

Example 10 provides the method of any of the preceding examples, where performing the convolutional operation on the grid representation includes generating a first grid representation and a second grid representation based on the grid representation, the first grid representation having a different structure from the second grid representation; and generating the grid-structured feature map based on the first grid representation and a second grid representation.

Example 11 provides one or more non-transitory computer-readable media storing instructions executable to perform operations, the operations including receiving, by a neural network, a graph representation of an object, the graph representation including a plurality of graph nodes; transforming, by the neural network, the graph representation to a grid representation of the object based on an assignment matrix, the grid representation including a plurality of grid nodes arranged in a grid structure that includes a plurality of grid elements, values of elements in the assignment matrix defining whether to assign any of the plurality of graph nodes to any of the plurality of grid elements; performing, by the neural network, a convolutional operation on the grid representation to generate a grid-structured feature map; and determining, by the neural network, a condition of the object based on the grid-structured feature map.

Example 12 provides the one or more non-transitory computer-readable media of example 11, where the values of the elements in the assignment matrix are determined through a process of training the neural network.

Example 13 provides the one or more non-transitory computer-readable media of example 12, where the convolutional operation is performed on the grid representation and a convolutional filter, and values of elements in the convolutional filter are determined in the process of training the neural network.

Example 14 provides the one or more non-transitory computer-readable media of example 12 or 13, where the values of the elements in the assignment matrix are determined by training a learnable matrix in the neural network in the process of training the neural network, values of elements in the learnable matrix having a continuous distribution; and after training the learnable matrix, converting the learnable matrix to the assignment matrix through a discretization operation, the values of the elements in the assignment matrix having a discrete distribution.

Example 15 provides the one or more non-transitory computer-readable media of example 14, where training the learnable matrix in the neural network in the process of training the neural network includes inputting training samples into the neural network, the training samples including graph representations of objects and associated with ground-truth labels indicating ground-truth conditions of objects illustrated in the training samples, the neural network processing the training samples and outputting conditions of the objects; and updating the values of the elements in the learnable matrix with a continuous gradient to minimize a difference between the ground-truth labels and the conditions of the objects.

Example 16 provides the one or more non-transitory computer-readable media of example 14 or 15, where converting the learnable matrix to the assignment matrix through the discretization operation includes identifying an element in a row in the learnable matrix, the element in the row having a value that is higher than values of other elements in the row; changing the value of the element in the row to a first value; and changing the value of the other elements in the row to a second value that is different from the first value.

Example 17 provides the one or more non-transitory computer-readable media of example 16, where the first value is 1, and the second value is 0.

Example 18 provides the one or more non-transitory computer-readable media of any one of examples 11-17, where determining a condition of the object based on the grid-structured feature map includes determining a pose of the object based on the grid-structured feature map.

Example 19 provides the one or more non-transitory computer-readable media of any one of examples 11-18, where the graph representation is a two-dimensional graph representation, and determining a condition of the object based on the grid-structured feature map includes generating a three-dimensional graph representation of the object based on the grid-structured feature map.

Example 20 provides the one or more non-transitory computer-readable media of any one of examples 11-19, where performing the convolutional operation on the grid representation includes generating a first grid representation and a second grid representation based on the grid representation, the first grid representation having a different structure from the second grid representation; and generating the grid-structured feature map based on the first grid representation and a second grid representation.

Example 21 provides an apparatus, the apparatus including a computer processor for executing computer program instructions; and a non-transitory computer-readable memory storing computer program instructions executable by the computer processor to perform operations including receiving, by a neural network, a graph representation of an object, the graph representation including a plurality of graph nodes, transforming, by the neural network, the graph representation to a grid representation of the object based on an assignment matrix, the grid representation including a plurality of grid nodes arranged in a grid structure that includes a plurality of grid elements, values of elements in the assignment matrix defining whether to assign any of the plurality of graph nodes to any of the plurality of grid elements, performing, by the neural network, a convolutional operation on the grid representation to generate a grid-structured feature map, and determining, by the neural network, a condition of the object based on the grid-structured feature map.

Example 22 provides the apparatus of example 21, where the values of the elements in the assignment matrix are determined through a process of training the neural network.

Example 23 provides the apparatus of example 22, where the convolutional operation is performed on the grid representation and a convolutional filter, and values of elements in the convolutional filter are determined in the process of training the neural network.

Example 24 provides the apparatus of example 22 or 23, where the values of the elements in the assignment matrix are determined by training a learnable matrix in the neural network in the process of training the neural network, values of elements in the learnable matrix having a continuous distribution; and after training the learnable matrix, converting the learnable matrix to the assignment matrix through a discretization operation, the values of the elements in the assignment matrix having a discrete distribution.

Example 25 provides the apparatus of any one of examples 21-24, where performing the convolutional operation on the grid representation includes generating a first grid representation and a second grid representation based on the grid representation, the first grid representation having a different structure from the second grid representation; and generating the grid-structured feature map based on the first grid representation and a second grid representation.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1-25. (canceled)

26. A method, the method comprising:
receiving, by a neural network, a graph representation of an object, the graph representation comprising a plurality of graph nodes;
transforming, by the neural network, the graph representation to a grid representation of the object based on an assignment matrix, the grid representation comprising a plurality of grid nodes arranged in a grid structure that comprises a plurality of grid elements, values of elements in the assignment matrix defining whether to assign any of the plurality of graph nodes to any of the plurality of grid elements;
performing, by the neural network, a convolutional operation on the grid representation to generate a grid-structured feature map; and
determining, by the neural network, a condition of the object based on the grid-structured feature map.

27. The method of claim 26, wherein the values of the elements in the assignment matrix are determined through a process of training the neural network.

28. The method of claim 27, wherein the convolutional operation is performed on the grid representation and a convolutional filter, and values of elements in the convolutional filter are determined in the process of training the neural network.

29. The method of claim 27, wherein the values of the elements in the assignment matrix are determined by:
training a learnable matrix in the neural network in the process of training the neural network, values of elements in the learnable matrix having a continuous distribution; and
after training the learnable matrix, converting the learnable matrix to the assignment matrix through a discretization operation, the values of the elements in the assignment matrix having a discrete distribution.

30. The method of claim 29, wherein training the learnable matrix in the neural network in the process of training the neural network comprises:
inputting training samples into the neural network, the training samples comprising graph representations of objects and associated with ground-truth labels indicating ground-truth conditions of objects illustrated in the training samples, the neural network processing the training samples and outputting conditions of the objects; and
updating the values of the elements in the learnable matrix with a continuous gradient to minimize a difference between the ground-truth labels and the conditions of the objects.

31. The method of claim 29, wherein converting the learnable matrix to the assignment matrix through the discretization operation comprises:
identifying an element in a row in the learnable matrix, the element in the row having a value that is higher than values of other elements in the row;
changing the value of the element in the row to a first value; and
changing the value of the other elements in the row to a second value that is different from the first value.

32. The method of claim 31, wherein the first value is 1, and the second value is 0.

33. The method of claim 26, wherein determining a condition of the object based on the grid-structured feature map comprises:
determining a pose of the object based on the grid-structured feature map.

34. The method of claim 26, wherein the graph representation is a two-dimensional graph representation, and determining a condition of the object based on the grid-structured feature map comprises:
generating a three-dimensional graph representation of the object based on the grid-structured feature map.

35. The method of claim 26, wherein performing the convolutional operation on the grid representation comprises:
generating a first grid representation and a second grid representation based on the grid representation, the first grid representation having a different structure from the second grid representation; and
generating the grid-structured feature map based on the first grid representation and a second grid representation.

36. One or more non-transitory computer-readable media storing instructions executable to perform operations, the operations comprising:
receiving, by a neural network, a graph representation of an object, the graph representation comprising a plurality of graph nodes;
transforming, by the neural network, the graph representation to a grid representation of the object based on an assignment matrix, the grid representation comprising a plurality of grid nodes arranged in a grid structure that comprises a plurality of grid elements, values of elements in the assignment matrix defining whether to assign any of the plurality of graph nodes to any of the plurality of grid elements;
performing, by the neural network, a convolutional operation on the grid representation to generate a grid-structured feature map; and
determining, by the neural network, a condition of the object based on the grid-structured feature map.

37. The one or more non-transitory computer-readable media of claim 36, wherein the values of the elements in the assignment matrix are determined through a process of training the neural network.

38. The one or more non-transitory computer-readable media of claim 37, wherein the convolutional operation is performed on the grid representation and a convolutional filter, and values of elements in the convolutional filter are determined in the process of training the neural network.

39. The one or more non-transitory computer-readable media of claim 37, wherein the values of the elements in the assignment matrix are determined by:
training a learnable matrix in the neural network in the process of training the neural network, values of elements in the learnable matrix having a continuous distribution; and
after training the learnable matrix, converting the learnable matrix to the assignment matrix through a discretization operation, the values of the elements in the assignment matrix having a discrete distribution.

40. The one or more non-transitory computer-readable media of claim 36, wherein determining a condition of the object based on the grid-structured feature map comprises:
determining a pose of the object based on the grid-structured feature map.

41. The one or more non-transitory computer-readable media of claim 36, wherein the graph representation is a two-dimensional graph representation, and determining a condition of the object based on the grid-structured feature map comprises:
generating a three-dimensional graph representation of the object based on the grid-structured feature map.

42. The one or more non-transitory computer-readable media of claim 36, wherein performing the convolutional operation on the grid representation comprises:
generating a first grid representation and a second grid representation based on the grid representation, the first grid representation having a different structure from the second grid representation; and
generating the grid-structured feature map based on the first grid representation and a second grid representation.

43. An apparatus, the apparatus comprising:
a computer processor for executing computer program instructions; and
a non-transitory computer-readable memory storing computer program instructions executable by the computer processor to perform operations comprising:
receiving, by a neural network, a graph representation of an object, the graph representation comprising a plurality of graph nodes,
transforming, by the neural network, the graph representation to a grid representation of the object based on an assignment matrix, the grid representation comprising a plurality of grid nodes arranged in a grid structure that comprises a plurality of grid elements, values of elements in the assignment matrix defining whether to assign any of the plurality of graph nodes to any of the plurality of grid elements,
performing, by the neural network, a convolutional operation on the grid representation to generate a grid-structured feature map, and
determining, by the neural network, a condition of the object based on the grid-structured feature map.

44. The apparatus of claim 43, wherein the values of the elements in the assignment matrix are determined through a process of training the neural network, the convolutional operation is performed on the grid representation and a convolutional filter, and values of elements in the convolutional filter are determined in the process of training the neural network.

45. The apparatus of claim 43, wherein performing the convolutional operation on the grid representation comprises:
generating a first grid representation and a second grid representation based on the grid representation, the first grid representation having a different structure from the second grid representation; and
generating the grid-structured feature map based on the first grid representation and a second grid representation.
